(19) United States
(12) Patent Application Publication
(10) Pub. No.: US 2025/0302216 A1
(43) Pub. Date: Oct. 2, 2025

(54) Folding Bowl Stand

(71) Applicant: Stephan Bianchi, Santa Cruz, CA (US)

(72) Inventor: Stephan Bianchi, Santa Cruz, CA (US)

(21) Appl. No.: 19/069,142

(22) Filed: Mar. 3, 2025

Related U.S. Application Data
(60) Provisional application No. 63/572,243, filed on Mar. 30, 2024.

(51) Int. Cl. A47G 19/08; A47J 47/16; F16M 11/38

(52) U.S. Cl. CPC A47G 19/08; A47J 47/16; F16M 11/38

(57) ABSTRACT

A folding bowl stand includes a hollow upper support portion including a plurality of first sections that are joined to one another by respective first hinges, and the hollow upper support portion being sloped outwardly from a bottom edge to a top edge thereof, and the hollow upper support portion configured to receive a bottom portion of an object so as to stabilize the object on a support surface; and a hollow lower support portion including a plurality of second sections that are joined to one another by respective second hinges, the hollow lower support portion being sloped inwardly from a bottom edge to a top edge thereof, the hollow lower support portion configured to be attached to the hollow upper support portion, and the hollow lower support portion being disposed underneath and supporting the hollow upper support portion in an operative state of the folding bowl stand.

### CROSS-REFERENCE TO RELATED APPLICATIONS

This patent application claims priority to, and incorporates by reference in its entirety, U.S. Provisional Patent Application No. 63/572,243, entitled “Folding Bowl Stand”, filed on Mar. 30, 2024.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### INCORPORATION BY REFERENCE OF MATERIAL SUBMITTED ON A COMPACT DISK

Not Applicable.

### BACKGROUND OF DISCLOSURE

### 1. Field of the Disclosure

The disclosure generally relates to a folding bowl stand that can be folded generally flat for transportation or storage.

### 2. Background

So that contents can be thoroughly mixed, interiors of mixing bowls tend to be hemispherical. To save material, weight and space and to enable them to nest for storage, most have roughly hemispherical exteriors as well. To prevent rolling, they usually have a minimally flattened base or a ring or feet that extend down below the curve. Still, when stirring contents with a whisk, spoon or other implement, the user must grasp the bowl with one hand while stirring with the other to prevent it from wobbling about. This poses problems for those with only one free and functional hand.

Unless they can be held in place by hand, curved objects must be chocked to prevent them from rolling. In the case of mixing bowls, an operator, using one hand to mix the contents of a vessel, may not have a second steady hand available to hold the bowl. The second hand may be holding a recording device, it may be crippled or missing. Cooks, especially smaller weaker ones, prefer lightweight utensils.

Rolling bowls can also be a problem for sailors and others when the countertop itself is unsteady. In either case, it is desirable to effectively broaden the base of the bowl to resist wandering, sliding and spilling. To save space, weight, material and expense, it is desirable to be able to use the same stabilizer with bowls of differing size and shape.

Existing bowl stabilizers hold different-sized bowls by means of a circular collar or funnel made of uniformly flexible semi-elastic and sticky material. To resist heat, they are typically made of silicone. To be stiff, they are thick. The result is that these devices, which may not be continually in use, are expensive, heavy and bulky, taking up much storage space. These problems may be compounded if one is using multiple bowls or other round objects simultaneously, for instance, if one wishes to display them.

Therefore, a need exists for a stand to secure mixing bowls, balls, or other curved objects. It is desirable that the stand be able to accommodate a variety of different radii. It also is desirable that the stand be made of a light, inexpensive material. It is also desirable that a stand fold flat for transportation and storage.

### SUMMARY OF THE DISCLOSURE

Accordingly, the present disclosure is directed to a folding bowl stand that substantially obviates one or more problems resulting from the limitations and deficiencies of the related art.

In accordance with one or more embodiments of the present disclosure, there is provided a folding bowl stand that includes a hollow upper support portion, the hollow upper support portion including a plurality of first sections, the first sections being joined to one another by respective first hinges, and the hollow upper support portion being sloped outwardly from a bottom edge of the hollow upper support portion to a top edge of the hollow upper support portion in an operative state of the folding bowl stand, and the hollow upper support portion configured to receive a bottom portion of an object in the operative state of the folding bowl stand so as to stabilize the object on a support surface; and a hollow lower support portion, the hollow lower support portion including a plurality of second sections, the second sections being joined to one another by respective second hinges, the hollow lower support portion being sloped inwardly towards a centerline of the folding bowl stand from a bottom edge of the hollow lower support portion to a top edge of the hollow lower support portion in the operative state of the folding bowl stand, the hollow lower support portion configured to be attached to the hollow upper support portion, and the hollow lower support portion being disposed underneath and supporting the hollow upper support portion in the operative state of the folding bowl stand.

In a further embodiment of the present disclosure, the hollow lower support portion is attached to the hollow upper support portion by one or more third hinges so that the folding bowl stand is able to be folded generally flat in a folded state of the folding bowl stand.

In yet a further embodiment, the hollow upper support portion and the hollow lower support portion have a polygonal shape that is selected from a group consisting of: (i) a hexagonal shape, (ii) a trapezoidal shape, (iii) a pyramidal shape, and (iv) a triangular shape; and the plurality of first sections of the hollow upper support portion form a plurality of first facets of the polygonal shape, and the plurality of second sections of the hollow lower support portion form a plurality of second facets of the polygonal shape.

In still a further embodiment, the hollow upper support portion is in a form of an inverted hollow truncated first cone, the hollow lower support portion is in a form of a hollow truncated second cone, and the hollow truncated second cone supports the inverted hollow truncated first cone in the operative state of the folding bowl stand.

In yet a further embodiment, the folding bowl stand further comprises a plurality of outer flaps joined to one or more of the plurality of second sections of the hollow lower support portion so as to stabilize the folding bowl stand in the operative state thereof.

In still a further embodiment, the folding bowl stand further comprises a closure tab attached to one of the plurality of outer flaps, the closure tab configured to wrap around a portion of the folding bowl stand in the folded state so as to help maintain the folding bowl stand in the folded state thereof.

In yet a further embodiment, at least one of the plurality of first sections of the hollow upper support portion includes one or more first tabs and at least another one of the plurality of first sections of the hollow upper support portion includes one or more second slots corresponding to the one or more first tabs so that the at least one of the plurality of first sections is able to be attached to the at least another one of the plurality of first sections in the operative state of the folding bowl stand.

In still a further embodiment, at least one of the plurality of second sections of the hollow lower support portion includes one or more second tabs and at least another one of the plurality of second sections of the hollow lower support portion includes one or more second slots corresponding to the one or more second tabs so that the at least one of the plurality of second sections is able to be attached to the at least another one of the plurality of second sections in the operative state of the folding bowl stand.

In yet a further embodiment, at least one of the plurality of second sections of the hollow lower support portion includes one or more third tabs and at least one of the plurality of first sections of the hollow upper support portion includes one or more third slots corresponding to the one or more third tabs so that the hollow lower support portion is able to be attached to the hollow upper support portion in the operative state of the folding bowl stand.

In still a further embodiment, at least a portion of the top edge of the hollow upper support portion of the folding bowl stand is serrated so as to accommodate objects having different circular diameters or objects having square bases.

In yet a further embodiment, at least one of the plurality of first sections of the hollow upper support portion includes one or more first holes and at least another one of the plurality of first sections of the hollow upper support portion includes one or more second holes corresponding to the one or more first holes so that the at least one of the plurality of first sections is able to be attached to the at least another one of the plurality of first sections by one or more first fastener members received within the one or more first and second holes in the operative state of the folding bowl stand.

In still a further embodiment, at least one of the plurality of second sections of the hollow lower support portion includes one or more third holes and at least another one of the plurality of second sections of the hollow lower support portion includes one or more fourth holes corresponding to the one or more third holes so that the at least one of the plurality of second sections is able to be attached by one or more second fastener members to the at least another one of the plurality of second sections received within the one or more third and fourth holes in the operative state of the folding bowl stand.

In yet a further embodiment, the hollow lower support portion is attached to the hollow upper support portion by one or more third hinges so that the folding bowl stand is able to be folded generally flat in a folded state of the folding bowl stand.

In still a further embodiment, at least one of the first hinges, the second hinges, and the one or more third hinges is in a form of a living hinge.

In yet a further embodiment, at least a portion of an interior of the hollow upper support portion comprises a sticky surface to facilitate a gripping of the object in the operative state of the folding bowl stand.

In still a further embodiment, the folding bowl stand further comprises a plurality of tabs hingedly attached to the bottom edge of the hollow lower support portion, the plurality of tabs configured to flatten out to grip the support surface in the operative state of the folding bowl stand.

In yet a further embodiment, at least one of the plurality of tabs has an underside that comprises a sticky surface to facilitate a gripping of the support surface on which the object is disposed in the operative state of the folding bowl stand.

In still a further embodiment, the folding bowl stand further comprises a fastening device attached to the hollow lower support portion, the fastening device keeping the folding bowl stand in a generally flat configuration when the folding bowl stand is in the folded state.

In accordance with one or more embodiments of the present disclosure, there is provided a folding bowl stand that includes an upper support portion, the upper support portion including a plurality of sections, the sections being joined to one another by respective hinges, and the upper support portion being sloped inwardly from a bottom edge of the upper support portion to a top edge of the upper support portion in an operative state of the folding bowl stand, and the upper support portion configured to receive a bottom portion of an object in the operative state of the folding bowl stand so as to stabilize the object on a support surface; and a plurality of base flaps hingedly joined to one or more of the plurality of sections of the upper support portion so as to stabilize the folding bowl stand in the operative state thereof.

In a further embodiment of the present disclosure, the folding bowl stand further

comprises one or more attachment devices being disposed on one or more of the plurality of base flaps, the one or more attachment devices configured to removably attach the one or more of the plurality of base flaps to the support surface in the operative state of the folding bowl stand.

It is to be understood that the foregoing general description and the following detailed description are merely exemplary and explanatory in nature. As such, the foregoing general description and the following detailed description should not be construed to limit the scope of the appended claims in any sense.

### BRIEF DESCRIPTION OF THE SEVERAL VIEWS OF THE DRAWINGS

The folding bowl stand will now be described, by way of example, with reference to the accompanying drawings, in which:

FIG. 1 is a top perspective view of a foldable hexagonal stand set up to support a bowl, according to a first illustrative embodiment;

FIG. 2 is a top perspective view of a stand similar to the stand of FIG. 1 in a process of folding the stand;

FIG. 3 is a top perspective view of the stand of FIG. 1 folded flat;

FIG. 4 is a side elevation of the stand as shown in FIG. 1 without the curved slices in the upper panels;

FIG. 5 is a side elevation of the stand as shown in FIG. 2;

FIG. 6 is a side elevation of the stand as shown in FIG. 3;

FIG. 7 is a top plan view of the stand as shown in FIG. 3 folded flat;

FIG. 8 is a top plan view of the stand of FIG. 1 without the curved slices in the upper panels;

FIG. 9 is a bottom plan view of the stand as shown in FIG. 1 without the curved slices in the upper panels;

FIG. 10 is a top plan view of a tabbed hex folding bowl stand disassembled, according to a second illustrative embodiment;

FIG. 11 is a perspective view of a rectangular stand set up to support an object, according to a third illustrative embodiment;

FIG. 12 is a top plan view of the stand shown in FIG. 11;

FIG. 13 is a front elevation of the stand of FIG. 11;

FIG. 14 is a side elevation of the stand of FIG. 11;

FIG. 15 is a top perspective view of the stand of FIG. 11 folded nearly flat;

FIG. 16 is a front elevation of the stand of FIG. 11 folded nearly flat;

FIG. 17 is a side elevation of the stand of FIG. 11 folded nearly flat;

FIG. 18 is a top plan view of the stand of FIG. 11 folded nearly flat;

FIG. 19 is a top perspective view of a two-pyramid square stand partly folded, according to a fourth illustrative embodiment;

FIG. 20 is a top perspective view of the stand of FIG. 19 folded nearly flat;

FIG. 21 is a top perspective view of a single-pyramid square stand set up to support an object, according to a fifth illustrative embodiment;

FIG. 22 is a top plan view of a hexagonal stand flat prior to assembly, according to a sixth illustrative embodiment;

FIG. 23 is a top perspective view of a triangular stand set up to support an object, according to a seventh illustrative embodiment;

FIG. 24 is a bottom perspective view of the stand of FIG. 23;

FIG. 25 is a top plan view of the stand of FIG. 23;

FIG. 26 is a side elevation of the stand of FIG. 23;

FIG. 27 is a top plan view of the stand of FIG. 23 folded; and

FIG. 28 is a side elevation of the stand of FIG. 23 folded.

Throughout the figures, the same parts are always denoted using the same reference characters so that, as a general rule, they will only be described once.

### DETAILED DESCRIPTION OF ILLUSTRATIVE EMBODIMENTS

In one or more embodiments, a folding bowl stand is disclosed that is primarily intended to secure a mixing bowl or other roughly hemispherical vessel to a flat work-surface. The folding bowl stand is designed to resist internal stirring or external tilting forces, but it can also be employed to elevate objects such as dog bowls or flowerpots to make them more visible or more accessible. The folding bowl stand also could affix and elevate globes, basketballs or other spherical objects. The folding bowl stand can bear plates or trays. Variations can be used to support other forms.

In one or more embodiments, a folding bowl stand is disclosed for securing objects above planar surfaces, roughly spherical or hemispherical objects in particular. The stand comprises thin panels joined by hinges such that it can be folded flat for transportation or storage. Where appropriate, surfaces can be coated or textured to resist rolling and sliding. A fastener can be provided to keep it folded when not in use.

In one or more embodiments, a folding bowl stand is disclosed that elevates and cradles an object such that it cannot slide or roll. The stand can accommodate standard-sized mixing bowls. The stand is essentially one conic section, which can be supported by another inverted one. The truncated cones can be faceted to form pyramids, constructed of flat panels joined by hinges such that it can be folded flat quickly and easily for portability and storage. When not in use, the stand can be collapsed flat, with all panels arranged parallel to each other.

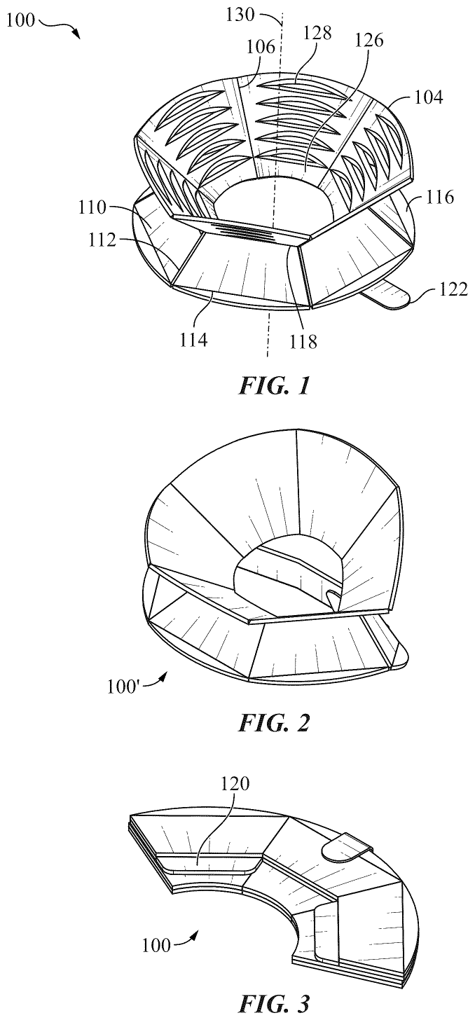

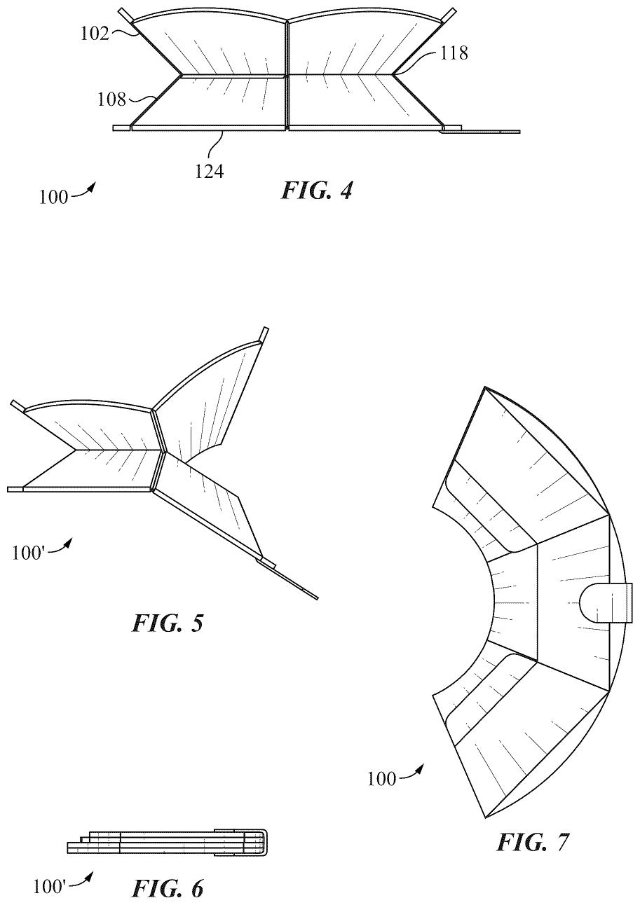

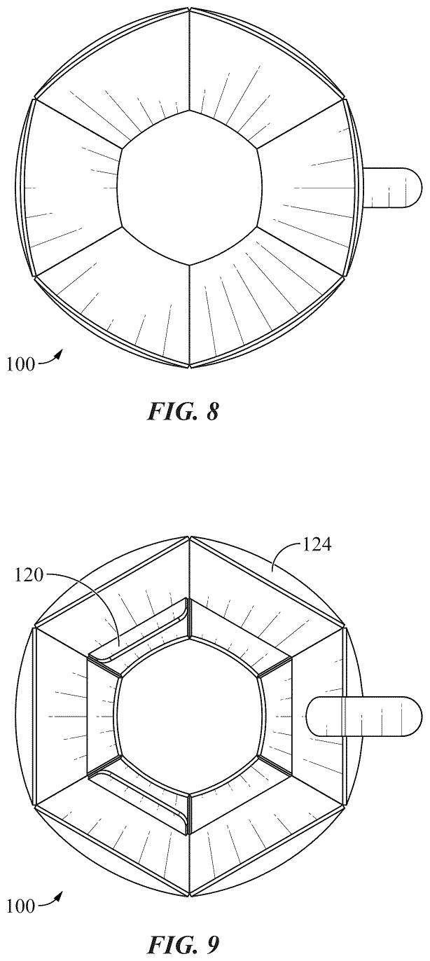

FIGS. 1-9 depict a first illustrative embodiment of a folding bowl stand, wherein the folding bowl stand is in a form of a hex stand 100, 100′. Referring to FIGS. 1 and 4, the stand 100 includes a hex upper pyramid 102, comprising six regular hex upper panels 104 joined together by hex upper hinges 106. In the illustrative embodiment, the upper pyramid 102 is generally mirrored by and supported by hex lower pyramid 108 (see FIGS. 1 and 4), which comprises six hex lower panels 110 joined by hex lower hinges 112. As shown in FIG. 1, in the illustrative embodiment, hex outer edges 114 are joined to outer flaps 116 by outer hinges. Hex upper pyramid 102 and hex lower pyramid 108 are joined by inner hinges 118 connecting two hex lower panels 110 to inner flaps 120, which are welded to two hex upper panels 104. When the unit is erect, the tabs can align to share a plane with a countertop (not shown). A clasp tab 122 is welded to one of the outer flaps 116, and when the unit is folded as shown in FIG. 3, it can be curled around to adhere to one of the hex upper panels 104 via hook-and-loop-fasteners (not shown).

In the illustrative embodiment, silicone is applied to the underside 124 of the outer flaps 116 (see FIG. 4), and the upper, inner surface 126 of hex upper panels 104. FIG. 1 shows curved slices 128 cut into the hex upper walls 104 to position flat circular disks (not shown).

In the illustrative embodiment, the folding bowl stand 100 includes a hollow upper support portion 102, the hollow upper support portion 102 including a plurality of first sections 104, the first sections 104 being joined to one another by respective first hinges 106, and the hollow upper support portion 102 being sloped outwardly from a bottom edge of the hollow upper support portion 102 to a top edge of the hollow upper support portion 102 in an operative state of the folding bowl stand 100 (see e.g., FIG. 1), and the hollow upper support portion 102 configured to receive a bottom portion of an object (e.g., a bowl) in the operative state of the folding bowl stand 100 so as to stabilize the object on a support surface (e.g., a countertop); and a hollow lower support portion 108, the hollow lower support portion 108 including a plurality of second sections 110, the second sections 110 being joined to one another by respective second hinges 112, the hollow lower support portion 108 being sloped inwardly towards a centerline 130 of the folding bowl stand from a bottom edge of the hollow lower support portion 108 to a top edge of the hollow lower support portion 108 in the operative state of the folding bowl stand 100, the hollow lower support portion 108 configured to be attached to the hollow upper support portion 102, and the hollow lower support portion 108 being disposed underneath and supporting the hollow upper support portion 102 in the operative state of the folding bowl stand 100 (see e.g., FIG. 4).

As shown in FIGS. 1 and 3, in the illustrative embodiment, it can be seen that the hollow lower support portion 108 is attached to the hollow upper support portion 102 by a plurality of third hinges 118 so that the folding bowl stand 100 is able to be folded generally flat in a folded state of the folding bowl stand 100 (see e.g., FIG. 3).

In the illustrative embodiment, referring again to FIG. 1, it can be seen that the folding bowl stand 100 comprises a plurality of outer flaps 116 joined to respective ones of the plurality of second sections 110 of the hollow lower support portion 108 so as to stabilize the folding bowl stand 100 in the operative state thereof.

In the illustrative embodiment, referring again to FIGS. 1 and 3, it can be seen that the folding bowl stand 100 comprises a closure tab 122 attached to one of the plurality of outer flaps 116, the closure tab 122 configured to wrap around a portion of the folding bowl stand 100 in the folded state (see e.g., FIG. 3) so as to help maintain the folding bowl stand 100 in the folded state thereof.

Now, an exemplary operation of the first illustrative embodiment of the folding bowl stand 100, 100′ will be described. In the first illustrative embodiment, to set up the six-sided stand 100, 100′, the strap or clasp tab 122 is unhitched and rotated around the common joint towards its original attachment point. The larger pyramid is thereby inserted upside-down into the smaller pyramid. The bowed tabs of the smaller pyramid are set on the countertop and flatten to conform to it. The bowl or other object can then be placed upon it.

In the first illustrative embodiment, to fold the six-sided stand 100, 100′, the upper panel over the strap is lifted and rotated back around to be secured by the strap or clasp tab 122.

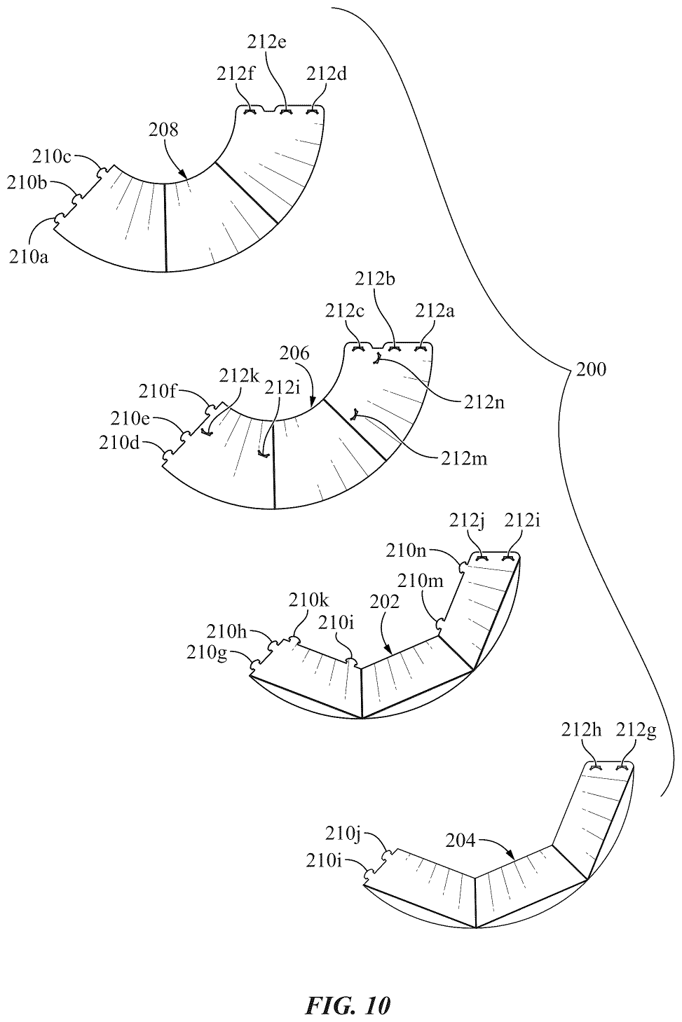

FIG. 10 depicts a second illustrative embodiment of a folding bowl stand, wherein the folding bowl stand is in a form of a tabbed hex folding stand 200. The second embodiment of the folding bowl stand is essentially a disassembled view of the first embodiment, but with a specific fastening scheme in a form of tabs to be inserted into slots. Ends of the lower panel 202 having inner tabs 210i, 210k, 210m, 210n is fitted to the lower panel 204 without inner tabs. Ends of the upper panel 206 having slots 212i, 212k, 212m, 212n is fitted to the upper panel 208 without slots. Tabs 210a-j snap into slots 212a-j respectively.

In the illustrative embodiment, the faceting of the cone of the stand 200 enables the tabs to avoid interfering with the bowl, and enables the bottom tabs to splay, contacting a worksurface.

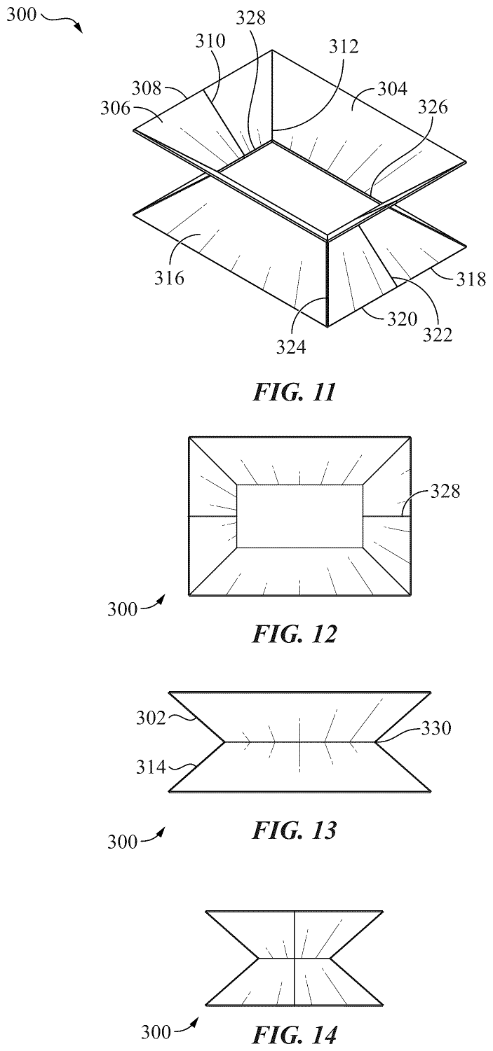

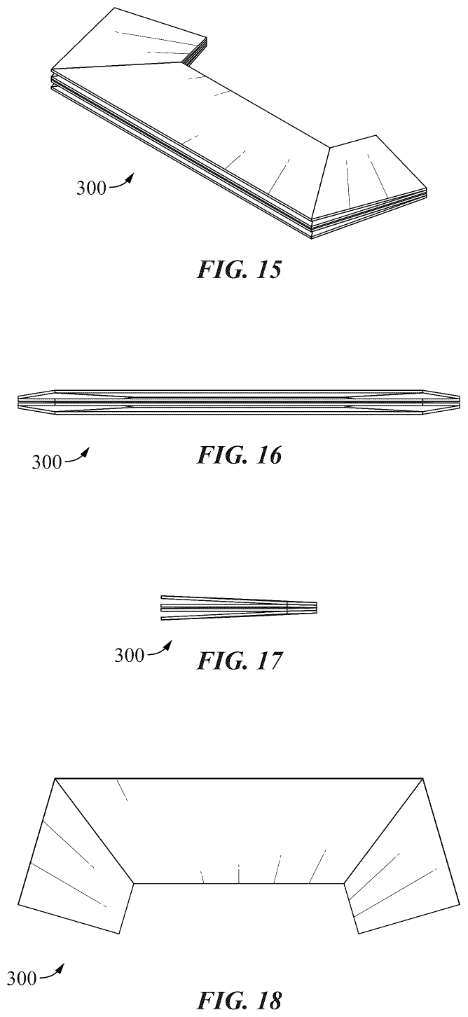

FIGS. 11-18 depict a third illustrative embodiment, quad folding stand 300, having a rectangular upper frame 302 having six panels: two (2) first symmetrical upper trapezoids 304 and four (4) identical upper right trapezoids 306 that are mirrored into pairs forming two second symmetrical upper trapezoids 308. All are hinged together by upper right hinges 310 or by upper diagonal hinges 312.

In the third illustrative embodiment, a rectangular lower frame 314 mirrors rectangular upper frame 302 (refer to FIGS. 11 and 13). The rectangular lower frame 314 also has six panels: two (2) first symmetrical lower trapezoids 316 and four (4) identical lower right trapezoids 318 that are mirrored into pairs forming two second symmetrical lower trapezoids 320. All are hinged together by lower right hinges 322 or by lower diagonal hinges 324 (see FIG. 11).

In the third illustrative embodiment, the upper and lower frames 302, 314 are held together by a first inner hinge 326 joining one first symmetrical upper trapezoid 304 to one first symmetrical lower trapezoid 316. Two (2) second inner hinges 328 join an upper right trapezoid 306 to a lower right trapezoid 318 on either side. The unit can be folded flat by pressing the joined upper and lower panels together, folding the second symmetrical trapezoids along the centerline 330.

Now, an exemplary operation of the third illustrative embodiment of the folding bowl stand 300 will be described. To fold the third embodiment, the first symmetrical upper trapezoid 304 and the first symmetrical lower trapezoid 316 that are hinged to each other are pressed together side-to-side. The other parts will then fold flat against each other.

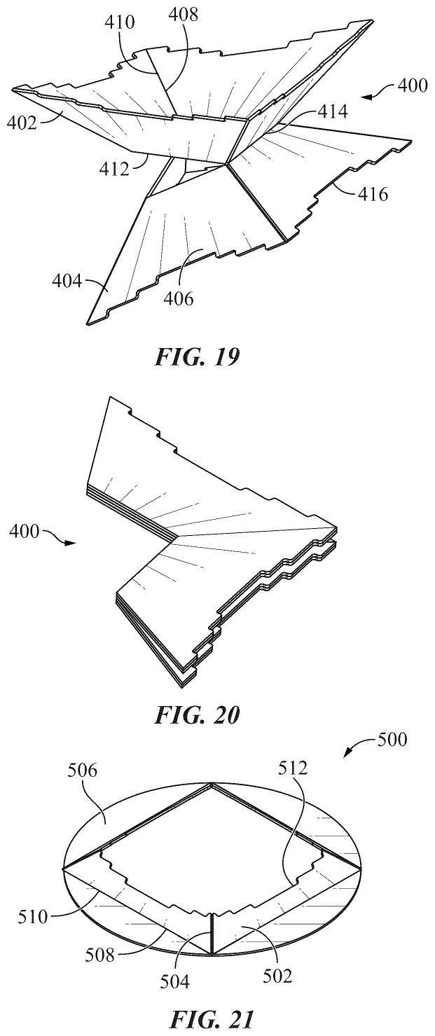

FIGS. 19 and 20 depict a fourth illustrative embodiment, square folding stand 400, having a square upper frame 402 and a square lower frame 404. Each frame 402, 404 is made up of four (4) essentially identical third symmetrical trapezoids 406, with diagonal edges 408, joined together by diagonal hinges 410. Inner edges 412, of two adjacent third symmetrical trapezoids on the square upper frame 402 are joined to the inner edges 412 of two adjacent third symmetrical trapezoids on the square lower frame 404 by horizontal hinges 414. Square outer edges 416 of third symmetrical trapezoids 406 are stepped to better grasp tops or bottoms of circular or square objects (not shown).

As shown in FIGS. 19-20, and the FIG. 21 embodiment described hereinafter, the edges of the square embodiments can be serrated ziggurat-style to cradle circular dishes, pans, or trays of different diameters, or of objects with square bases.

FIG. 21 depicts a fifth illustrative embodiment, flapped square folding stand 500. Four (4) trapezoids 502 are joined by four (4) hinges 504. Four (4) flaps 506 are joined to four (4) outer edges 508 by four (4) flap hinges 510. Four (4) inner edges 512 are stepped to better grasp bottoms of circular or square objects (not shown).

As shown in the illustrative embodiment of FIG. 21, flaps 506 can be hinged to the lower edges 508 of a pyramid to prevent the panels 502 from flexing sideways and to provide more surface area to increase friction and inhibit sliding or spinning on a work surface.

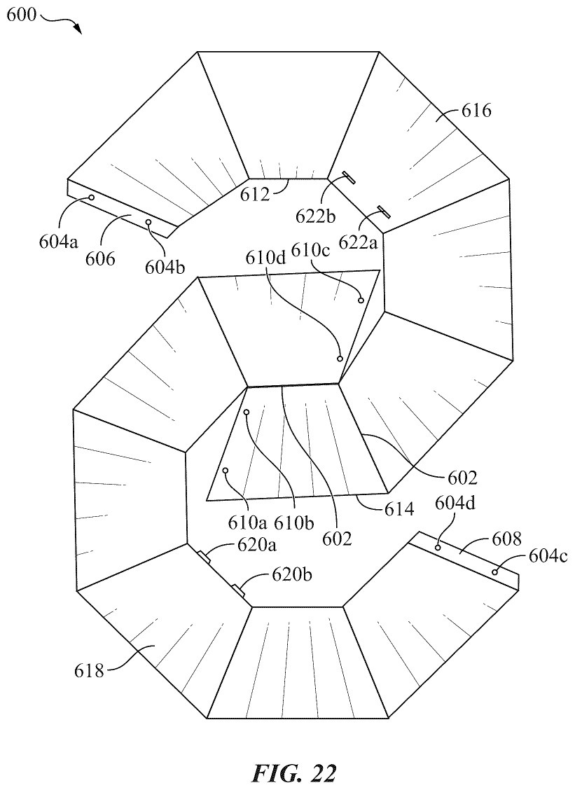

FIG. 22 depicts a sixth illustrative embodiment in the form of a solid sheet stand 600. Living hinges are created by pinching, planning or perforating along hinge lines 602. Registration holes 604a, b, c, and d on upper tab 606 and lower tab 608 are to be aligned with holes 610a, b, c, and d, respectively, and fastened with rivets (not shown). Where possible, the upper facet inner edges 612, extend farther than the lower facet inner edges 614, so that when erected, the upper portion 616 nests in the lower portion 618. Locating tabs 620a and 620b mate with locating slots 622a and 622b to stabilize the stand 600 when it is erected. This design would permit the stand to be stamped in one piece from a flat sheet.

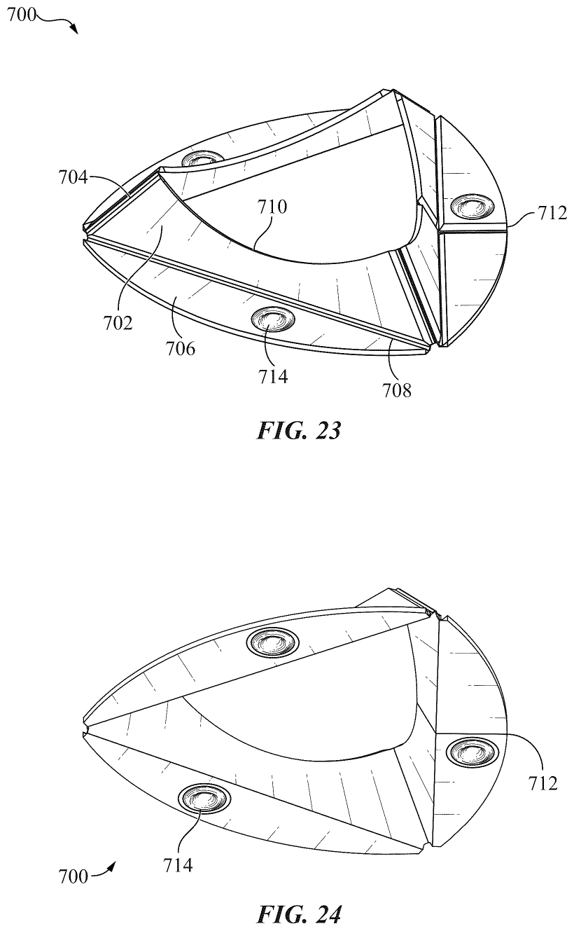

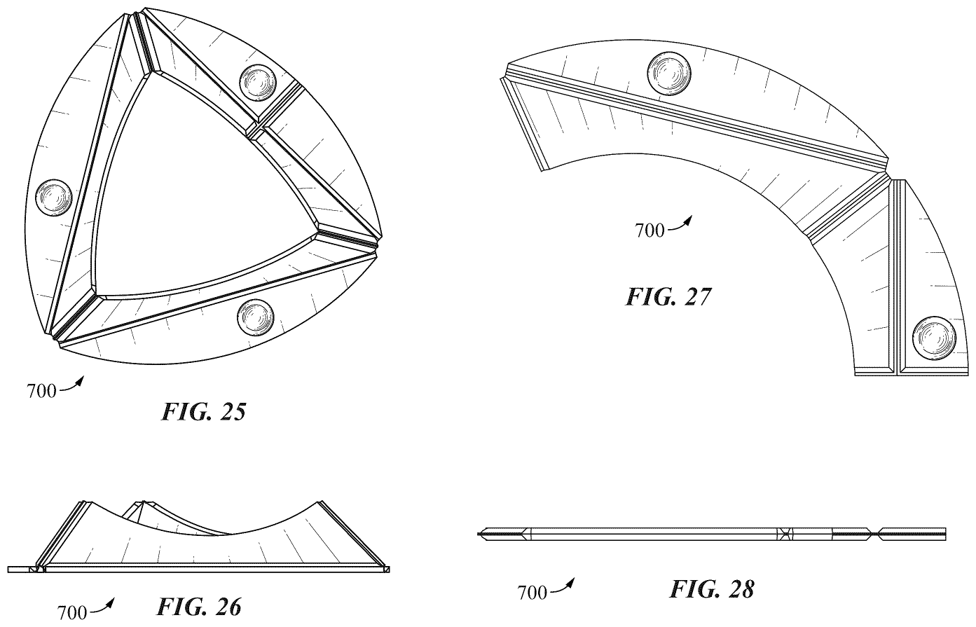

FIGS. 23-28 depict a seventh illustrative embodiment of the stand, flapped triangular folding stand 700. Three triangle panels 702 are joined by three triangle hinges 704. Triangle flaps 706 are joined to the outer edges of triangle panels 702 by triangle hinges 708. The inner portions of triangle panels 702 are cut away to create inner triangular edges 710. Central hinge 712 (see FIGS. 23 and 24) crosses one triangle panel and one triangle hinge, dividing them each in half. Suction cups 714 are integrated into each of the triangle flaps 706.

In an alternative embodiment, magnets may be used in place of the suction cups 714 for detachably securing the folding stand 700 to a support surface (e.g., when the support surface comprises a metallic support surface, such as a stainless steel countertop).

In the illustrative embodiment, the folding bowl stand 700 includes an upper support portion, the upper support portion including a plurality of sections 702, the sections being joined to one another by respective hinges 704, and the upper support portion being sloped inwardly from a bottom edge of the upper support portion to a top edge of the upper support portion in an operative state of the folding bowl stand 700 (see e.g., FIG. 23), and the upper support portion configured to receive a bottom portion of an object in the operative state of the folding bowl stand 700 so as to stabilize the object on a support surface (e.g., a countertop); and a plurality of base flaps 706 hingedly joined to respective ones of the plurality of sections 702 of the upper support portion so as to stabilize the folding bowl stand 700 in the operative state thereof.

As shown in FIGS. 23 and 24, in the illustrative embodiment, it can be seen that the folding bowl stand 700 further comprises a plurality of attachment devices (e.g., suction cups 714) being disposed on respective ones of the plurality of base flaps 706. The plurality of attachment devices 714 configured to removably attach the plurality of base flaps 706 to the support surface in the operative state of the folding bowl stand 700.

Now, an exemplary operation of the seventh illustrative embodiment of the folding bowl stand 700 will be described. In the seventh illustrative embodiment, the flapped triangular folding stand 700 can be folded by pressing the tops of suction cups 714 while pulling up on triangle flaps 706. The flaps can be aligned with triangle panels 702. Then, central hinge 712 can be folded. The structure can be flattened and the suction cups 714 can hold it flat.

To erect the three-sided stand 700, the far ends of the flattened stand are pressed towards each other until the shorter segments align and a truncated pyramid is formed. The bowed edges are then placed on a countertop and the pyramid pressed down until the bowed sections lie flat. The bowl can now be placed upon it.

The folding bowl stand 700 of the seventh embodiment is simple and easy to set up. The stand 700 is very thin and neat when folded, but it effectively supports fewer sizes and shapes. Medium-sized bowls are held at six (6) places, but the largest bowls, pressing on the struts near the joints, are held by three (3) points, more inclined to wobble or to allow tipping than the aforementioned designs. This design is best tailored to fit a particular size of bowl or sphere.

Any of the stands 100, 100′, 200, 300, 400, 500, 600, 700 in the above-described illustrative embodiments can be made from one semi-flexible material such as polyethylene, polypropylene, Nylon, polyvinyl chloride (PVC), or from a combination of materials including stiff materials, such as acrylonitrile butadiene styrene (ABS), wood or metal.

In the above-described illustrative embodiments, one or more of the upper panels can be hinged to the lower panels. They can be living hinges created by engraving of, or perforation of, the base material or comprising other sorts of hinges including piano hinges, affixed via rivet, cement, weld, snap, dovetail or other means.

In the above-described illustrative embodiments, the hinges can be made of a more flexible material. That material can be co-molded. Living hinges can be molded in, or parts can be cemented, heat-staked, riveted, bolted, dovetailed or otherwise joined together.

In one or more embodiments, the hinges could also be made of steel for heavy-duty applications such as tire stands.

In one or more embodiments, dovetail joints can serve in place of hinges.

In the above-described illustrative embodiments, the interior of the upper pyramid can be coated to induce stiction against bowls to keep them steady. This can be applied to the entire interior, or only to the center of the facets, where they would contact the bowl. The same material can be applied to the top edges of the triangular embodiment. The top edges of the triangular or other embodiments can be serrated ziggurat-style to provide level rests for circular dishes, pans, or trays of different diameters, or of objects with bases of triangular or other shapes.

In the above-described illustrative embodiments, the underside of the structure can be coated to induce stiction.

In the above-described illustrative embodiments, stiction surfaces can be co-molded into the base material. They can be snapped, glued or otherwise affixed. They can be applied in the form of tape. Instead of, or in addition to stiction materials, the countertop or contained object can be secured by suction cups, magnets, or other means mounted on the outer flaps.

In one or more embodiments, the two (2) pyramids can be faceted in a variety of ways with different numbers of panels. In one or more other embodiments, two (2) cones can be substituted for the pyramids, sewn together or fastened together with two or more small tabs. The stand can cling to a countertop via multiple small tabs or by edges made of elastic material that splay outward to provide stiction contact with a planar surface. The outer flaps can be expanded to place more surface area in contact with a work surface. They can also be modeled to grasp a pin, bar, or other locating feature. The flaps that are located at the center when the stand is folded can be eliminated to narrow the stand for storage.

In one or more embodiments, the strap holding the farthest flat surfaces of the folding bowl stand stabilizer together to keep it slender and stiff when folded can be permanently affixed to a facet at one end via rivet, cement, weld or other means and affixed at the other by hook-and-loop, snap, magnet or other temporary means. The strap can be replaced by a clip or hook or chain or other means, or an outer upper and an outer lower panel can bear snap, hook-and-loop or other fastening methods, with intermediate panels cut away, permitting them to clasp through, rather than around those panels. If the material is stiff enough, it may tend to stay flat when folded, negating the need for such fasteners.

Features applied to any one embodiment can generally be applied to any other embodiment.

It is readily apparent that the aforedescribed folding bowl stand 100, 100′, 200, 300, 400, 500, 600, 700 offers numerous advantages and benefits. For example, the stand 100, 100′, 200, 300, 400, 500, 600, 700 is lightweight and makes it easier to use bowls not relying on added-on bases or heavy material for inertia. Most cooks have minimum storage space available. The user may even wish to carry the stand in a pocket or purse when traveling. Also, the disclosed device 100, 100′, 200, 300, 400, 500, 600, 700 is unique when compared with other known devices and solutions because it provides: (1) a rigid, lightweight stand; (2) that folds flat (3) gripping a flat surface; and (4) gripping the object supported.

In addition, the disclosed device 100, 100′, 200, 300, 400, 500, 600, 700 is unique in that it is structurally different from other known devices or solutions. More specifically, the device is unique due to the presence of: (1) rigid, lightweight panels held together by: (2) hinges; (3) to form a conical or pyramidal shape or shapes.

Advantageously, the folding bowl stand 100, 100′, 200, 300, 400, 500, 600, 700 thus described can be employed to position essentially hemispherical cooking vessels and other similarly shaped objects semi-permanently on a work surface. It can be used by cooks who, due to paralysis, loss, or multi-tasking, lack a second operable free hand with which to steady a bowl while the other hand is stirring. The stand may also be employed on shipboard or a mobile home to prevent bowls from rolling about when not hand-held. Suction-cups enable it to grip smooth wet surfaces to prevent sliding. Use of this stand enables the safe use of space-saving nesting bowls that take up minimal space.

In addition, the folding bowl stand 100, 100′, 200, 300, 400, 500, 600, 700 can be employed to elevate objects such as birdbaths or dog bowls for increased visibility or accessibility.

Moreover, the folding bowl stand 100, 100′, 200, 300, 400, 500, 600, 700 can be employed to secure or display spherical items such as globes or basketballs, and variations can be used to hold objects of different shapes.

Furthermore, the folding bowl stand 100, 100′, 200, 300, 400, 500, 600, 700 can effortlessly be folded with one hand into a neat flat package for shipping or storage. When folded, the sticky surfaces are covered, thus protected from collecting dust.

Index of Illustrated Elements:

First Embodiment of Folding Bowl Stand

100: hex folding stand

100′: alternative hex folding stand

102: hex upper pyramid

104: hex upper panels

106: hex upper hinges

108: hex lower pyramid

110: hex lower panels

112: hex lower hinges

114: hex outer edges

116: hex outer flaps

118: hex inner hinges

120: inner flaps

122: clasp tab

124: underside of hex folding stand

126: upper inner surface

128: curved slices

Second Embodiment of Folding Bowl Stand

200: tabbed hex folding stand

202: lower panel having inner tabs

204: lower panel without inner tabs

206: upper panel having slots

208: upper panel without slots

210a-n: tabs

212a-n: slots

Third Embodiment of Folding Bowl Stand

300: quad folding stand

302: rectangular upper frame

304: first symmetrical upper trapezoids

306: upper right trapezoids

308: second symmetrical upper trapezoids

310: upper right hinges

312: upper diagonal hinges

314: rectangular lower frame

316: first symmetrical lower trapezoids

318: lower right trapezoids

320: second symmetrical lower trapezoids

322: lower right hinges

324: lower diagonal hinges

326: first inner hinge

328: second inner hinges

330: centerline

Fourth Embodiment of Folding Bowl Stand

400: square folding stand

402: square upper frame

404: square lower frame

406: symmetrical trapezoids

408: diagonal edges

410: diagonal hinges

412: inner edges

414: horizontal hinges

416: square outer edges

Fifth Embodiment of Folding Bowl Stand

500: flapped square folding stand

502: trapezoids

504: hinges

506: flaps

508: outer edges

510: flap hinges

512: inner edges

Sixth Embodiment of Folding Bowl Stand

600: solid sheet stand

602: living hinges

604a-d: registration holes

606: upper tab

608: lower tab

610a-d: holes

612: upper facet inner edges

614: lower facet inner edges

616: upper portion

618 lower portion

620a, b: locating tabs

622a, b: locating slots

Seventh Embodiment of Folding Bowl Stand

700: flapped triangular folding stand

702: triangle panels

704: triangle hinges

706: triangle flaps

708: outer edges

710: inner triangular edges

712: central hinge

714: suction cups

Any of the features or attributes of the above described embodiments and variations can be used in combination with any of the other features and attributes of the above described embodiments and variations as desired.

Although the folding bowl stand has been shown and described with respect to certain embodiments, it is apparent that the aforedescribed folding bowl stand can be embodied in many different forms and that many other modifications and variations are possible without departing from the spirit and scope of the claimed invention.

Moreover, while exemplary embodiments have been described herein, one of ordinary skill in the art will readily appreciate that the exemplary embodiments set forth above are merely illustrative in nature and should not be construed as to limit the claims in any manner. Rather, the scope of the invention is defined only by the appended claims and their equivalents, and not, by the preceding description.

The invention claimed is:

1. A folding bowl stand, comprising:
a hollow upper support portion, the hollow upper support portion including a plurality of first sections, the first sections being joined to one another by respective first hinges, and the hollow upper support portion being sloped outwardly from a bottom edge of the hollow upper support portion to a top edge of the hollow upper support portion in an operative state of the folding bowl stand, and the hollow upper support portion configured to receive a bottom portion of an object in the operative state of the folding bowl stand so as to stabilize the object on a support surface; and
a hollow lower support portion, the hollow lower support portion including a plurality of second sections, the second sections being joined to one another by respective second hinges, the hollow lower support portion being sloped inwardly towards a centerline of the folding bowl stand from a bottom edge of the hollow lower support portion to a top edge of the hollow lower support portion in the operative state of the folding bowl stand, the hollow lower support portion configured to be attached to the hollow upper support portion, and the hollow lower support portion being disposed underneath and supporting the hollow upper support portion in the operative state of the folding bowl stand.

2. The folding bowl stand according to claim 1, wherein the hollow lower support portion is attached to the hollow upper support portion by one or more third hinges so that the folding bowl stand is able to be folded generally flat in a folded state of the folding bowl stand.

3. The folding bowl stand according to claim 1, wherein the hollow upper support portion and the hollow lower support portion have a polygonal shape that is selected from a group consisting of: (i) a hexagonal shape, (ii) a trapezoidal shape, (iii) a pyramidal shape, and (iv) a triangular shape; and
the plurality of first sections of the hollow upper support portion form a plurality of first facets of the polygonal shape, and the plurality of second sections of the hollow lower support portion form a plurality of second facets of the polygonal shape.

4. The folding bowl stand according to claim 1, wherein the hollow upper support portion is in a form of an inverted hollow truncated first cone, the hollow lower support portion is in a form of a hollow truncated second cone, and the hollow truncated second cone supports the inverted hollow truncated first cone in the operative state of the folding bowl stand.

5. The folding bowl stand according to claim 1, further comprising a plurality of outer flaps joined to one or more of the plurality of second sections of the hollow lower support portion so as to stabilize the folding bowl stand in the operative state thereof.

6. The folding bowl stand according to claim 5, further comprising a closure tab attached to one of the plurality of outer flaps, the closure tab configured to wrap around a portion of the folding bowl stand in the folded state so as to help maintain the folding bowl stand in the folded state thereof.

7. The folding bowl stand according to claim 1, wherein at least one of the plurality of first sections of the hollow upper support portion includes one or more first tabs and at least another one of the plurality of first sections of the hollow upper support portion includes one or more second slots corresponding to the one or more first tabs so that the at least one of the plurality of first sections is able to be attached to the at least another one of the plurality of first sections in the operative state of the folding bowl stand.

8. The folding bowl stand according to claim 7, wherein at least one of the plurality of second sections of the hollow lower support portion includes one or more second tabs and at least another one of the plurality of second sections of the hollow lower support portion includes one or more second slots corresponding to the one or more second tabs so that the at least one of the plurality of second sections is able to be attached to the at least another one of the plurality of second sections in the operative state of the folding bowl stand.

9. The folding bowl stand according to claim 8, wherein at least one of the plurality of second sections of the hollow lower support portion includes one or more third tabs and at least one of the plurality of first sections of the hollow upper support portion includes one or more third slots corresponding to the one or more third tabs so that the hollow lower support portion is able to be attached to the hollow upper support portion in the operative state of the folding bowl stand.

10. The folding bowl stand according to claim 1, wherein at least a portion of the top edge of the hollow upper support portion of the folding bowl stand is serrated so as to accommodate objects having different circular diameters or objects having square bases.

11. The folding bowl stand according to claim 1, wherein at least one of the plurality of first sections of the hollow upper support portion includes one or more first holes and at least another one of the plurality of first sections of the hollow upper support portion includes one or more second holes corresponding to the one or more first holes so that the at least one of the plurality of first sections is able to be attached to the at least another one of the plurality of first sections by one or more first fastener members received within the one or more first and second holes in the operative state of the folding bowl stand.

12. The folding bowl stand according to claim 11, wherein at least one of the plurality of second sections of the hollow lower support portion includes one or more third holes and at least another one of the plurality of second sections of the hollow lower support portion includes one or more fourth holes corresponding to the one or more third holes so that the at least one of the plurality of second sections is able to be attached by one or more second fastener members to the at least another one of the plurality of second sections received within the one or more third and fourth holes in the operative state of the folding bowl stand.

13. The folding bowl stand according to claim 12, wherein the hollow lower support portion is attached to the hollow upper support portion by one or more third hinges so that the folding bowl stand is able to be folded generally flat in a folded state of the folding bowl stand.

14. The folding bowl stand according to claim 13, wherein at least one of the first hinges, the second hinges, and the one or more third hinges is in a form of a living hinge.

15. The folding bowl stand according to claim 1, wherein at least a portion of an interior of the hollow upper support portion comprises a sticky surface to facilitate a gripping of the object in the operative state of the folding bowl stand.

16. The folding bowl stand according to claim 1, further comprising a plurality of tabs hingedly attached to the bottom edge of the hollow lower support portion, the plurality of tabs configured to flatten out to grip the support surface in the operative state of the folding bowl stand.

17. The folding bowl stand according to claim 16, wherein at least one of the plurality of tabs has an underside that comprises a sticky surface to facilitate a gripping of the support surface on which the object is disposed in the operative state of the folding bowl stand.

18. The folding bowl stand according to claim 1, further comprising a fastening device attached to the hollow lower support portion, the fastening device keeping the folding bowl stand in a generally flat configuration when the folding bowl stand is in the folded state.

19. A folding bowl stand, comprising:
an upper support portion, the upper support portion including a plurality of sections, the sections being joined to one another by respective hinges, and the upper support portion being sloped inwardly from a bottom edge of the upper support portion to a top edge of the upper support portion in an operative state of the folding bowl stand, and the upper support portion configured to receive a bottom portion of an object in the operative state of the folding bowl stand so as to stabilize the object on a support surface; and
a plurality of base flaps hingedly joined to one or more of the plurality of sections of the upper support portion so as to stabilize the folding bowl stand in the operative state thereof.

20. The folding bowl stand according to claim 19, further comprising one or more attachment devices being disposed on one or more of the plurality of base flaps, the one or more attachment devices configured to removably attach the one or more of the plurality of base flaps to the support surface in the operative state of the folding bowl stand.
